(19) United States
(12) Patent Application Publication
(10) Pub. No.: US 2016/0134711 A1
(43) Pub. Date: May 12, 2016

(54) Geography-Based Intercommunication Content Delivery System

(71) Applicant: geoXMF, LLC, Lafayette, CO (US)

(72) Inventors: Keith G. Croteau, Ann Arbor, MI (US); Doran J. Geise, Topeka, KS (US); Thomas D. Mahar, III, Lafayette, CO (US)

(73) Assignee: geoXMF, LLC, Lafayette, CO (US)

(21) Appl. No.: 14/923,075

(22) Filed: Oct. 26, 2015

Related U.S. Application Data
(60) Provisional application No. 62/078,118, filed on Nov. 11, 2014.

(51) Int. Cl. H04L 29/08; H04W 4/02

(52) U.S. Cl. CPC H04L 67/18; H04W 4/02

(57) ABSTRACT

A computer-implemented geography-based intercommunication content delivery system including a processor in communication with a memory element containing a computer code which upon execution implements a graphical user interface on a display surface of a client device which allows a recipient user to define or select one or more communication content delivery locations inside of a geographic map space, and optionally variably adjust a geographic boundary delimiting a geographic area defining which publishers can deliver publications to the communication content delivery locations, and allows a publisher user to adjust the geography boundary within the geographic map space to delimit the geographic area defining a plurality of communication delivery locations to which the publisher user delivers publications.

This United States Non-Provisional Patent Application claims the benefit of U.S. Provisional Patent Application No. 62/078,118, filed Nov. 11, 2014, hereby incorporated by reference herein.

### FIELD OF INVENTION

A computer-implemented geography-based intercommunication content delivery system including a processor in communication with a memory element containing a computer code which upon execution implements a graphical user interface on a display surface of a client device which allows a recipient user to define or select one or more communication content delivery locations inside of a geographic map space, and optionally variably adjust a geographic boundary delimiting a geographic area defining which publishers can deliver publications to the communication content delivery locations, and allows a publisher user to adjust the geography boundary within the geographic map space to delimit the geographic area defining a plurality of communication delivery locations to which the publisher user delivers publications.

### BACKGROUND

The innocuous mailbox has been a part of the information delivery landscape for over a hundred years. It connects people from around the world; those sending information with those receiving it. Businesses recognize the value of communicating through the mail system and spend enormous resources on direct mail campaigns to pitch their products and influence recipient purchasing decisions. Those direct mail campaigns end up filling our mailboxes with a tremendous amount of mail. Mail is not bad, per se—most people enjoy reading about products, reviews and service opportunities that are of personal interest. Virtualization has already taken over a number of aspects of daily life that have traditionally been tied to a physical location. People work in virtual offices. They communicate on mobile devices that have long been detached from the wall in their house. Television, radio and movies are less and less tied to the living room and increasingly delivered to widespread locations on a variety of platforms. Why do we still have mailboxes at the end of our driveways and more importantly why do direct mail campaigns only target our interests in the immediate vicinity of those mailboxes?

There would be an advantage in a geography-based intercommunication content delivery system affording recipient users and publisher users a geographic map space in which communication content delivery locations are identified and in which either the recipient user or the publisher user can define a geographic target area respectively defining a subpopulation of publishers from which publications can be received at a communication content delivery location or defining a subpopulation of communication content delivery locations to which a publisher can deliver publications.

### SUMMARY OF THE INVENTION

Accordingly, a broad object of the invention can be to provide a computer-implemented geography-based intercommunication content delivery system including a processor in communication with a memory element containing a computer code which upon execution implements a graphical user interface on a display surface of a client device which allows a recipient user to define one or more communication content delivery locations inside of a geographic map space and which publishers can deliver publications to the one or more communication content delivery locations.

Another broad object of the invention can be to provide a computer implemented method of geography-based intercommunication content delivery by which a recipient user within a graphical user interface defines one or more communication content delivery locations inside of a geographic map space and which publishers can deliver publications to the communication content delivery locations.

Another broad object of the invention can be to provide a computer-implemented geography-based intercommunication content delivery system including a processor in communication with a memory element containing a computer code which upon execution implements a graphical user interface on a display surface of a client device which allows a publisher user to define a plurality of communication delivery locations to which the publisher user delivers publications.

Another broad object of the invention can be to provide a computer-implemented method of geography-based intercommunication content delivery by which a publisher user within a graphical user interface defines a plurality of communication delivery locations to which publications are delivered.

Naturally, further objects of the invention are disclosed throughout other areas of the specification, drawings, photographs, and claims.

### A BRIEF DESCRIPTION OF THE DRAWINGS

FIG. 1 is a block diagram of a particular embodiment of a computer-implemented geography-based intercommunication content delivery system.

FIG. 2 is a block diagram of an illustrative computer means, network means and computer-readable medium which provides computer-executable instructions to provide an embodiment of the computer-implemented geography-based intercommunication content delivery system.

FIG. 3 is an illustration of particular embodiment of a graphic user interface which allows a recipient user to define one or more communication content delivery locations inside of a geographic map space and as to particular embodiments variably adjust a geographic boundary delimiting a geographic area defining which publishers can deliver publications to the communication content delivery locations.

FIG. 4 is an illustration of a particular embodiment of a graphic user interface which displays a geographic map space including one or more communication content delivery locations each definable by recipient user interaction to retrieve publications delivered to the selected communication content delivery location and displays publication configuration selector which by recipient user interaction causes presentation of the plurality of publications delivered to the defined communication content delivery location to be presented in the selected publication configuration.

FIG. 5 is an illustration of particular embodiment of a graphic user interface which allows a publisher user to adjust a geography boundary within a geographic map space to delimit the geographic area defining a plurality of communication delivery locations to which the publisher user delivers publications.

### DETAILED DESCRIPTION OF THE PREFERRED EMBODIMENTS

A computer-implemented geography-based intercommunication content delivery system including a processor in communication with a memory element containing a computer code which upon execution implements a graphical user interface on a display surface of a client device which allows a recipient user to define or select one or more communication content delivery locations inside of a geographic map space, and optionally variably adjust a geographic boundary delimiting a geographic area defining which publishers can deliver publications to the communication content delivery locations, and allows a publisher user to adjust the geography boundary within the geographic map space to delimit the geographic area defining a plurality of communication delivery locations to which the publisher user delivers publications.

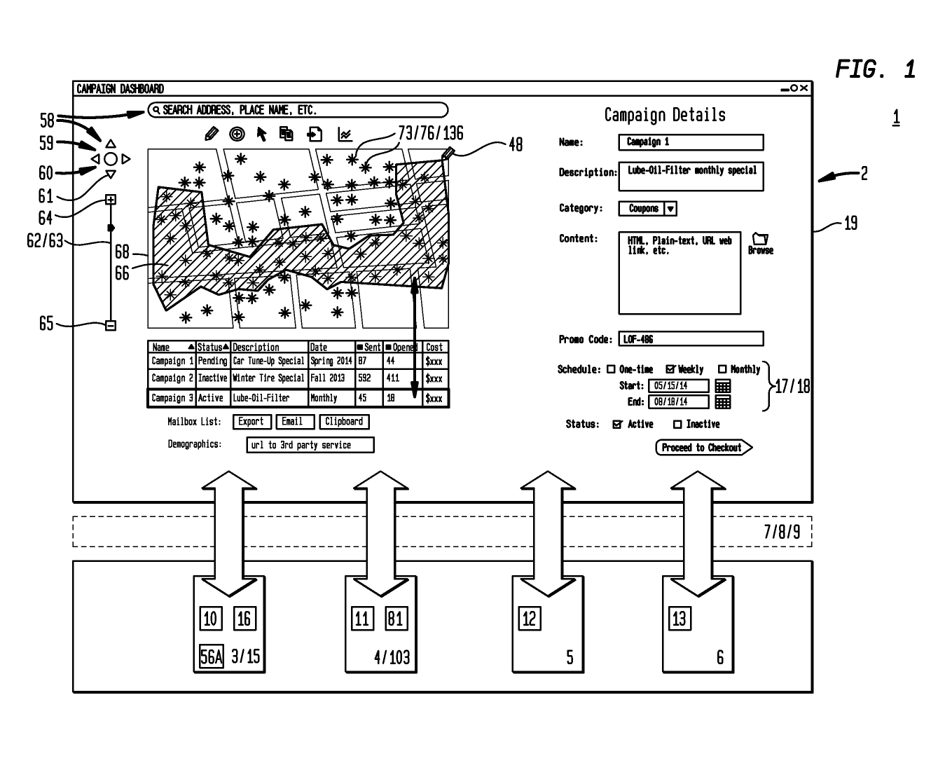

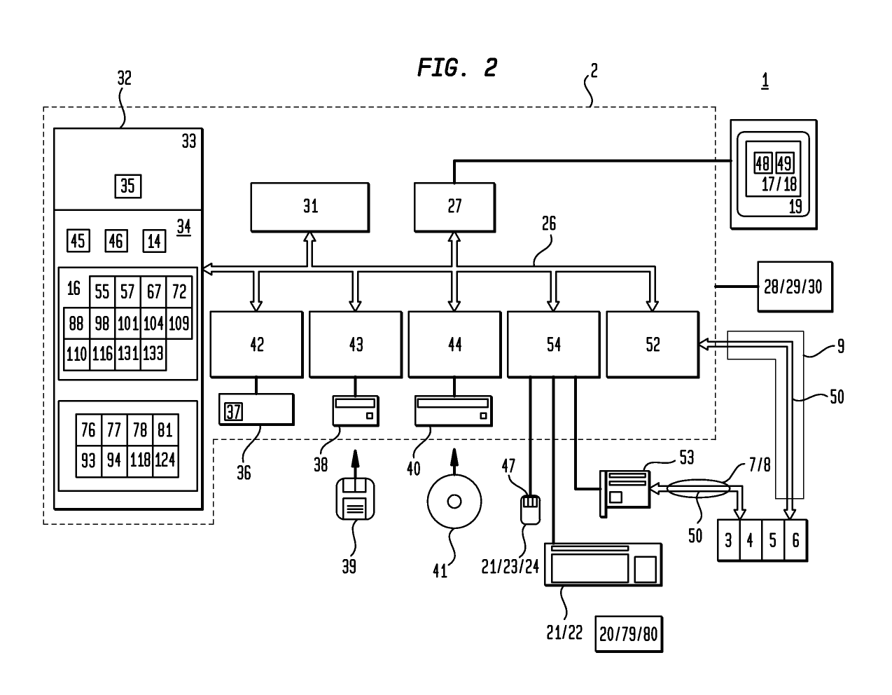

Now referring primarily to FIGS. 1 and 2, which generally illustrate computer means, certain network means, and computer readable media which can be utilized to practice embodiments of a geography-based intercommunication content delivery system (1). It is not intended that embodiments of the invention be practiced in only wide area computing environments or only in local computing environments, but rather the invention can be practiced in local computing environments or in distributed computing environments where functions or tasks are performed by remote processing devices that are linked through a communications network. In a distributed computing environment, program modules may be located in both a local or in a remote memory storage device(s) or device elements.

Also while a preferred embodiment of the invention is described in the general context of a processor in communication with a memory which includes a computer code or computer-executable instructions such as an application program and program modules which utilize routines, programs, objects, components, data structures, or the like, to perform particular functions or tasks or implement particular abstract data types, or the like, it is not intended that embodiments of the invention be limited to a particular computer code, set of computer-executable instructions or protocols.

Now referring to primarily to FIG. 1, one or more client devices (2) can be configured to connect with one or more server computers (3)(4)(5)(6) through a wide area network (“WAN”) (7), such as the Internet (8), or one or more local area networks (“LAN”)(9) to transfer corresponding images and data (10)(11)(12)(13). As to particular embodiments, the one or more client devices (2) can take the form of a limited-capability computer designed specifically for navigation on the World Wide Web of the Internet (8). Alternatively, the one or more client devices (2) might be set-top boxes, intelligent televisions connected to receive data through an entertainment medium such as a cable television network or a digital satellite broadcast, hand-held devices such as smart phones, slate or pad computers, personal digital assistants or camera/cell phone, or multiprocessor systems, microprocessor-based or programmable consumer electronics, network PCs, minicomputers, mainframe computers, or the like.

Again referring primarily to FIGS. 1 and 2, in general, each of the one or more client devices (2) can include an Internet browser (14) such as Microsoft's INTERNET EXPLORER, GOOGLE CHROME, MOZILLA FIREFOX, or the like, which functions to download and render multimedia content that is formatted in hypertext markup language (“HTML”). In this environment, a first server computer (15) might contain a computer code (16) which implements the most significant portions of a graphical user interface (17). As to these embodiments, the computer code (16) which implements the user interface (17) can be resident in the first server computer (15)(as shown in the example of FIG. 1) and the one or more client devices (2) can use the Internet browser (14) to simply display downloaded content and to relay user inputs back to the first server computer (15). The first server computer (15) would respond by formatting one or more new screen displays (18) of the graphical user interface (17) and downloading them for display on the display on the display surface (19) one or more of the client devices (2).

In other embodiments, the one or more server computers (3)(4)(5)(6) can be used primarily as sources of images and data (10)(11)(12)(13), with primary responsibility for implementing the graphical user interface (17) being placed upon each of the one or more client devices (2). While illustrative examples in this description attribute a certain type of images and data (10)(11)(12)(13) to one of the server computers (3)(4)(5)(6) for clarity, it is to be understood that various types of images and data (10)(11)(12)(13) may reside in any of the one or more server computers (3)(4)(5)(6) and embodiments of the invention can utilize a number of server computers (3)(4)(5)(6) to a lesser or greater extent depending upon the application.

The computer code (16) can further function to provide images and data (10)(11)(12)(13) obtained from one or more server computers (3)(4)(5)(6) in a common format, as further described below.

A user (20) can enter commands and information into one or more client devices (2) through one or more input devices (21) such as a keyboard (22) or a pointing device (23) such as a mouse (24); however, any method or device that converts user (20) action into commands and information can be utilized including, as illustrative examples: a microphone, joystick, game pad, touch screen, or the like. A display surface (19) such as a monitor screen (25) or other type of display device can also be connected to a bus (26) via a video display interface (27), such as a video adapter, or the like. The user interface can in part be presented as an interactive graphical user interface (17) on the display surface (19) of the client device (2). In addition to the display surface (19), each of the one or more client devices (2) can further include other peripheral output devices (28) such as speakers (29) and printers (30); although the peripheral output devices (28) are not so limited.

Now referring primarily to FIG. 2, as an illustrative example, a client device (2) can provide a processing unit (31), one or more memory elements (32), and a bus (26) which operably couples components of the client computer (2), including the memory elements (32) to the processing unit (31). The processing unit (31) can comprise one central-processing unit (“CPU”), or a plurality of processing units which operate in parallel to process digital information. The bus (26) may be any of several types of bus configurations including a memory bus or memory controller, a peripheral bus, and a local bus using any of a variety of bus architectures. The one or more memory elements (32) can be a read only memory (“ROM”) (33) or a random access memory (“RAM”) (34), or both. A basic input/output system (“BIOS”) (35), containing routines that assist transfer of data between the components of the client device (2), such as during start-up, can be stored in ROM (33). The client device (2) can further include a hard disk drive (36) for reading from and writing to a hard disk (37), a magnetic disk drive (38) for reading from or writing to a removable magnetic disk (39), and an optical disk drive (40) for reading from or writing to a removable optical disk (41) such as a CD ROM or other optical media. The hard disk drive (36), magnetic disk drive (38), and optical disk drive (40) can be connected to the bus (26) by a hard disk drive interface (42), a magnetic disk drive interface (43), and an optical disk drive interface (44), respectively. The drives and their associated computer-readable media provide nonvolatile storage of computer-readable instructions, data structures, program modules and other data for the client device (2). It can be appreciated by those skilled in the art that any type of computer-readable media that can store data that is accessible by a computer, such as magnetic cassettes, flash memory cards, digital video disks, Bernoulli cartridges, random access memories (RAMs), read only memories (ROMs), and the like, may be used in a variety of operating environments. A number of program modules may be stored on or included in the hard disk drive (36), magnetic disk (39), optical disk (41), ROM (33), or RAM (34), including an operating system (45), one or a plurality of application programs (46) and in particular the computer code (16) which implements the graphical user interface (17) or other interfaces of the invention.

“User interaction” occurs when the user (20) operates a function of the computer code (16) through the use of a command which for example can include pressing or releasing the left mouse button (47) while a pointer (48) is located over a control icon (49)(or other interactive field which activates a function) displayed in the graphical user interface (17). However, it is not intended that “user interaction” be limited to the press and release of the left mouse button (47) while a pointer (48) is located over a control icon (49)(or field), rather, “user interaction” is intend to broadly encompass a command by the user (20) through which a function of the computer code (16)(or other program, application, module or the like) can be activated or performed, whether through point-click of one or a plurality of control icon(s) (49) (or fields), or by user voice command, keyboard stroke, mouse button, touch on a touch screen, swipe gesture, heads up display, or otherwise or a combination thereof. It is further intended that control icons (49) can be configured or displayed without limitation as a bullets, point, a circle, a triangle, a square, a polygon (or other geometric configurations or combinations or permutations thereof), or as fields or boundary elements created in displayed images, or as fields in which locations, addresses, or other terms can be entered manually or by operation of computer code (16), or a portion or element thereof, such as: a street address, a zip code, a county code, a natural area code, a latitude/longitude, coordinates X and Y, coordinates X, Y, and Z, or other notation, script, character, or the like.

The one or more client devices (2) may operate in a networked environment using one or more logical connections (50) to connect to one or more of server computers (3)(4)(5)(6). These logical connections (50) can be achieved by one or more communication devices (51) coupled to or a part of the client computer (2); the invention is not limited to a particular type of communications device (51). The one or more server computers (3)(4)(5)(6) can be another computer, a server, a router, a network personal computer, a client, a peer device or other common network node, and can include a part or all of the elements above-described relative to the client computer (2). The logical connections (50) depicted in FIG. 2 can include a LAN (9) or WAN (7). Such networking environments are commonplace and include for example:

enterprise-wide computer networks, intranets, wireless networks, global satellite networks, cellular phone networks and the Internet (8), or the like.

When used in a LAN-networking environment, the client computer (2) can be connected to the LAN (9) through a network interface (52) or adapter, which is one type of communications device (51). When used in a WAN-networking environment, the client device (2) typically includes a modem (53), a type of communications device (51), or other type of communications device for establishing communications over the WAN (7), such as the Internet (8)(as shown in the example of FIGS. 1 and 2). The modem (53), which may be internal or external, is connected to the bus (26) via a serial port interface (54). In a networked environment, application programs (46) or the computer code (16) depicted relative to the client computer (2), or portions thereof, may be as to certain embodiments of the invention be stored in the one or more server computers (3)(4)(5)(6) (as shown in the examples of FIGS. 1 and 2). It is appreciated that the network connections shown are exemplary and other means of and communications devices for establishing a communications link between the client computers (2) can be used.

Again referring primarily to FIGS. 1 and 2, the client device (2) can encompass one client device or a plurality of client devices each of which can be operated by a user (20) to activate the computer code (18) to generate one or more screen displays (18) of the graphical user interface (17) in a common format on display surface (19) of the client device (2).

### The Geographic Map Space.

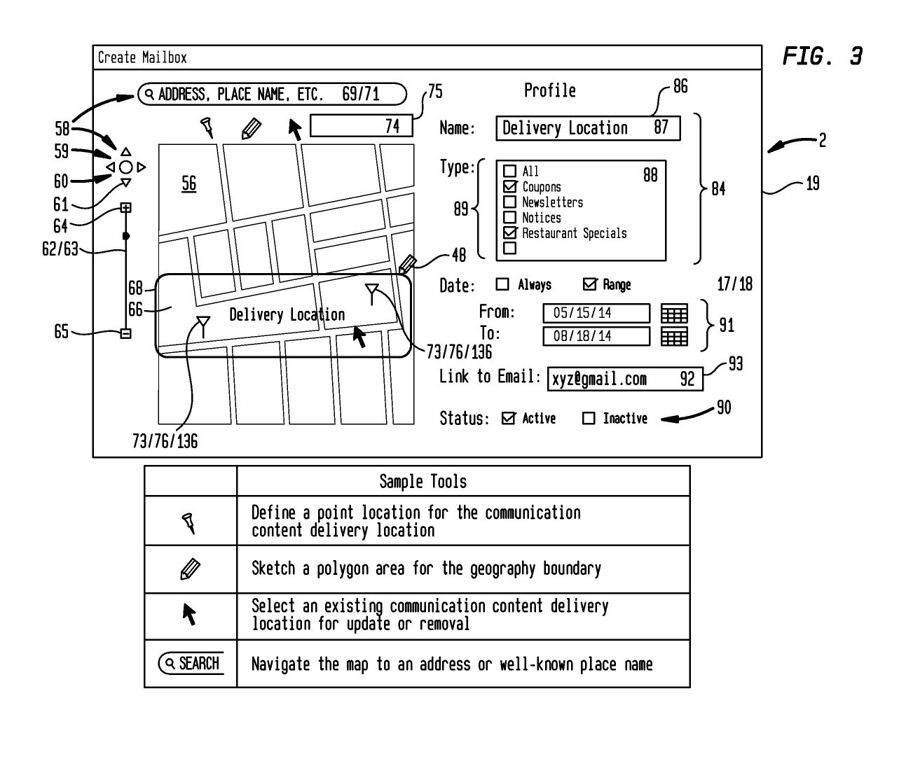

Now referring primarily to FIGS. 3 through 5 which show exemplary embodiments of a graphical user interface (17) in accordance with the invention. The graphical user interface (17) can be implemented using various technologies and different devices, depending on the preferences of the designer and the particular efficiencies desired for a given circumstance. By user interaction, the user (20) can activate the computer code (16) which in part includes a user interface module (55) which functions to display the screen displays (18) of the graphical user interface (17) on a display surface (19) of a client device (2). The computer code (16) further includes a geographic map space generator (55) which upon activation by user interaction in the graphical user interface (17) displays a geographic map space (56) in the graphical user interface (17) on the display surface (19) of the client device (2).

In the examples provided by FIGS. 3 through 5, the geographic map space generator (55) can access a first server computer (15)(as shown in the example of FIG. 1) to serve map server applications (56A), such as: GOOGLE MAPS, MAPQUEST, BING MAPS, or the like. The map server applications (56A) can be implemented in any commercially available relational database system (RDBMS) such as: Oracle, Microsoft SOL Server, Microsoft Access, IBM DB2. The system does not need to be implemented using an RDBMS. The implementation could be through any data structure (object database, text file, etc.) capable of storing the required data and data relationships. Also, in some embodiments no pre-defined data structure may be required, and all relationships are auto-calculated based on coordinate relationships and user defined parameters. For Internet applications, a web server can further act to implement a standard web server software, such as Microsoft IIS, Apache, or the like.

The geographic map space (56) can take one or more of a wide variety of viewable forms having any number of dimensions, any manner of symmetry, geometric properties, whether finite or infinite. The geographic map space (56) can take the form of a diagrammatic multi-dimensional (two dimensional, three dimensional, or the like) representation of the features of an area of the earth showing them in their respective forms, sizes, and relationships including representations of one or more of: geographic boundaries such as rivers, mountains, or the like; artificial boundaries delineating countries, regions, states, counties, postal codes, or the like; artificial features such as roadways, towns, buildings, structures, or the like; land use such as agriculture, ranching, commercial, residential, recreational, or the like.

The computer code (16) can further include a navigation control module (57) which functions to display a navigation controller (58) in the graphical user interface (17). The geographic map space (56) can be operably coupled to the navigation controller (58) which by user interaction allows selection of portions of the geographic map space (56) for viewing in the graphical user interface (17) which, at the displayed scale, lie outside of the graphical user interface (17).

As to certain embodiments, the navigation controller (58) can take the form of navigation controls (59) displayed in the graphical user interface (17). As to certain embodiments, the navigation controls (59) can include a pan control (60) displayed in the form of one or more arrows (61) correspondingly pointing in one or more cardinal directions. An arrow (61) by user interaction activates the computer code (16) to pan the geographic map space (56) directionally in the graphical user interface (17) (North, South, East, or West combinations thereof).

The navigation controller (58) can further include a zoom control (62) operably coupled to the geographic map space (56) to allow the a portion of the geographic map space (56) to be increased or decreased in scale in the graphical user interface (17). As to certain embodiments, the zoom control (62) can be displayed in the graphical user interface (17) in the form of a slider element (63) which can be dragged up or down to correspondingly increase or decrease the scale of the of the viewable portion of the geographic map space (56) viewed in the graphical user interface (17) and can further include a plus icon (64) or a minus icon (65) which by user interaction correspondingly increases or decreases scale of the viewable portion of the geographic map space (56).

However, these examples of panning or zooming of the geographic map space (56) are illustrative and other embodiments can allow the geographical map space (56) to be panned, zoomed, or oriented by entry or selection of search terms (whether coordinates X and Y, coordinates X, Y, and Z, a street address, a zip code, a county code, a natural area code, place names, landmarks, administrative boundaries, or the like) or otherwise navigated or manipulated by user interaction including one or more of: touch, pointer, key stroke, mouse drag, menu, toolbar, voice or the like.

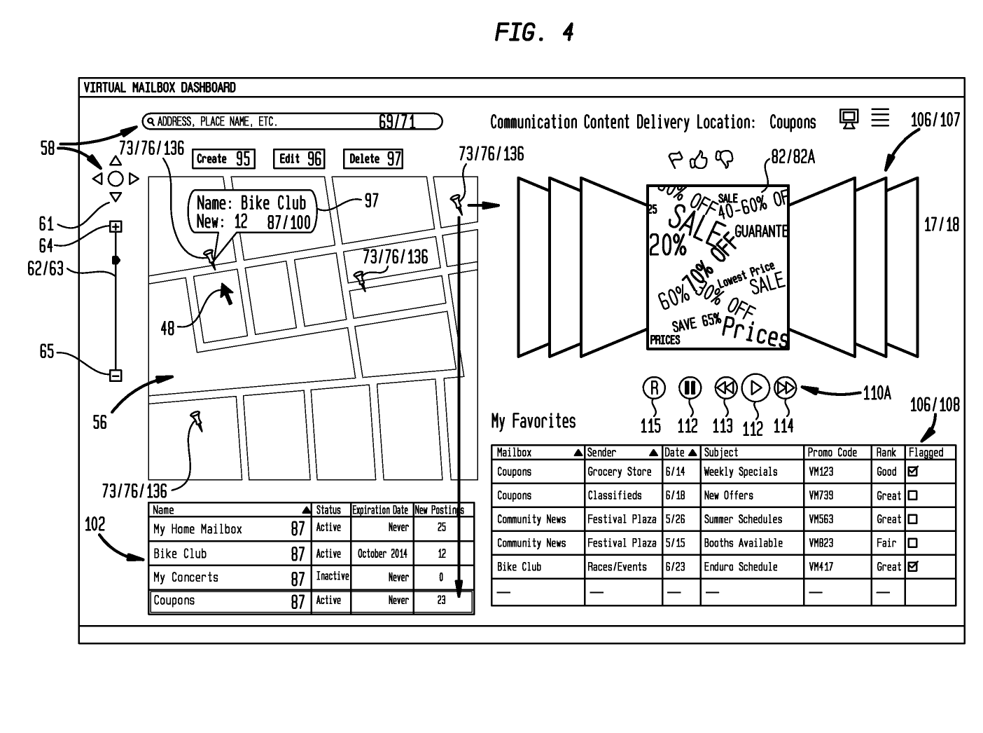

Now referring primarily to FIG. 3, by user interaction with the graphical user interface (17) a geographic target area (66) can be defined within geographic map space (56) by execution of a geographic boundary generator module (67). As to particular embodiments, a geographic boundary generator module (67) of the computer code (16) can display a pointer (48) or other type of viewable indicia in the graphical user interface (17) which by user interaction allows a geographic boundary (68) to be variably adjusted to define the target geographic area (66) in the geographic map space (56). While the geographic boundary (68) shown in the example of FIG. 3 is substantially rectangular; the invention is not so limited, and the geographic boundary can be established as a free form polygonal geographic boundary (68) which bounds and defines a free form polygonal geographic target area (66) as shown in the example of FIGS. 1 and 4. The user (20) can establish the geographic boundary (68) in any form which bounds at least a portion of the geographic map space (56); for example, the geographical boundary (68) can be established by the user (20) as a rectangle, circle, oval, irregular polygon, free form shape, or otherwise.

Again referring primarily to FIG. 3, as to particular embodiments, the user (20) can adjust the geographic boundary (68) displayed in the geographic map space (56), as above described, or based on selection of one or more geographic target area criteria (69) in the graphical user interface (17), or both. The geographic target area criteria (69) can be any geographic area which can be defined in a coordinate system, such as Cartesian, Cylindrical

Polar, Spherical Polar, or other user defined coordinate system. As examples, geographic target area criteria (69) can include one or more of, or be selected from the group consisting of: a continent, a country, a state, a county, a city, a neighborhood, an address, a latitude coordinate, a longitude coordinate, an elevation coordinate, a postal zone area, a political area, an administrative area, or the like, and combinations thereof.

The target area criteria (69) can be displayed in the graphical user interface (17) in any manner which allows selection by user interaction and by way of illustrative example: drop down lists (70) including countries, states, counties, cities, towns, zip codes, or the like; search fields (71) in which street addresses, zip codes, county codes, natural area codes, latitude/longitude coordinates or projected coordinate X and Y, or the like, can be entered manually or entered automatically by operation of the computer code (16).

### The Communication Content Delivery Location.

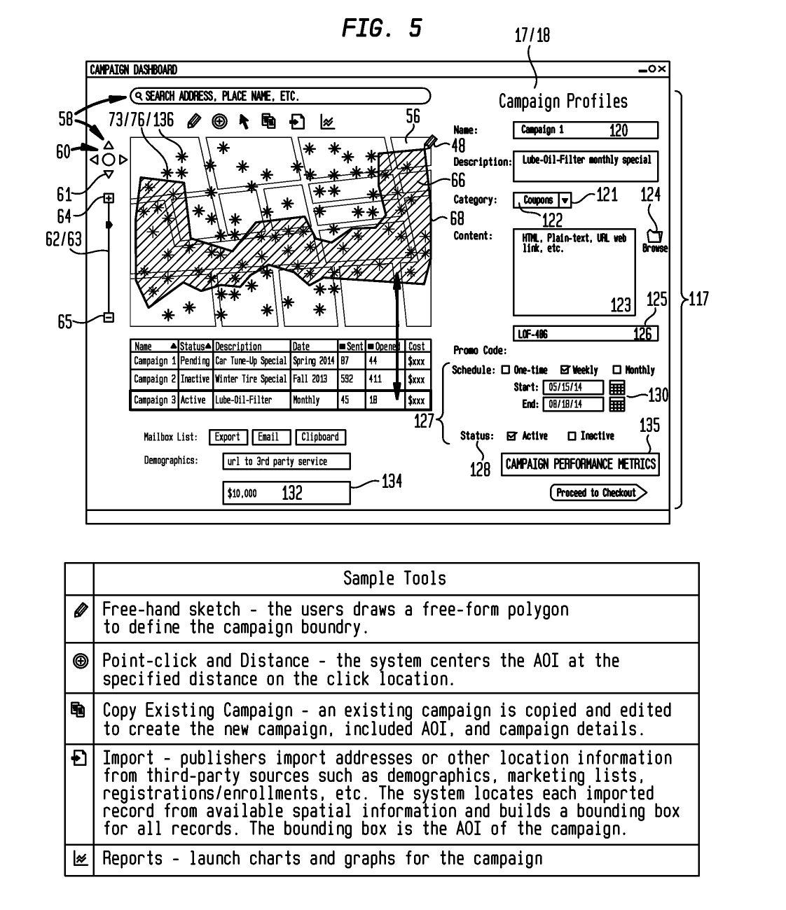

Now referring primarily to FIG. 3, the computer code (16) can further include a communication content delivery location selection module (72) executable by user interaction in the geographic map space (56) to define or select one or more communication content delivery locations (73). As to particular embodiments, the user (20) can create a communication content delivery location (73) by user interaction in the geographic map space (56) whether by moving a pointer (48) or other viewable indicia to a location in the geographic map space (65), or by entry of location coordinates (74) into a communication content delivery location coordinate entry field (75) associated with the geographic map space (56), or by using a coordinate look-up process to derive geographic coordinates of locations, places, landmarks, structures, addresses, or the like, or by retrieval of global positioning system coordinates whether using a client device (2) or other discrete device. By point-click, submission or download of the defined, selected or derived location coordinates, the communication content delivery location selection module (72) functions to create a communication content delivery location (73) having fixed geographic coordinates (76) (as opposed to mobile coordinates associated with a portable device) corresponding to the defined or selected location in the geographic map space (56) associated with a communication content delivery location profile (77) and user account information (78). The communication content delivery locations (73) can be defined or selected with or without utilization of a geographic boundary (68), or with or without a defined or selected geographic target area (66). The communication content deliver location (73) can be represented in the geographic map space (56) by a location indicator (136) (as shown in the example of FIGS. 1 and 5 as “*” and as shown in the examples of FIG. 3 as a triangular symbol, and as shown in FIG. 4 as a “push pin”).

### Recipients, Publishers and Publications.

A “recipient (79)” or the purpose of this invention means any user (20) whether a person, a business, an organization, or other entity capable of receiving a publication (81) from a publisher (80). A “publisher (80)” for the purpose of this invention means any user (20) whether a person, a business, an organization, or other entity that creates a publication (81) for delivery to a recipient (79). A “publication (81)” for the purposes of this invention means a computer data file in any format retrievably maintained in a computer readable form in one or more a memory elements (32) of one or more computer servers (3)(4)(5)(6) or client device (2) having file contents deliverable to a communication content delivery location (73). The publication (81) may in whole or in part be convertible to display in a graphical user interface (17) as a publication image (82) viewable by a recipient (79) along with the associated metadata or other data which matches, couples or links the publication (81) or publication image (82) to a communication content delivery location (73), location coordinates (74), date and time stamp, other media, or other sensorially perceivable elements (whether or not displayable on the display surface) such as: a person, a place, an animal, an object, one or more characters, words or other media such as video or video clips, sound elements (whether audible or inaudible), tactile elements (vibration, touch, or the like), olfactory elements (scents, odors, or the like), taste elements (whether as bitter, salty, sour, sweet or combinations as a flavor), or the like. Accordingly, the use of the teen “publication” whether as part of the description or claims does not limit the term to only a computer file deliverable to a communication content delivery location (73) or convertible to a publication image (82), but further includes, the associated data to implement use of the publication (81) or publication image (82) in accordance with any embodiment of the invention.

### The Communication Content Delivery Location Profile.

The computer code (16) can further include a communication content delivery location profile module (83) which functions to generate in the graphic user interface (17) a communication content profile field (84)(as shown in the example of FIG. 3) which allows the recipient (79) to create a communication content delivery location profile (85) associated with the communication content deliver location (73). A feature of the communication content profile field (84) can be a communication content delivery location identifier field (86) which by user interaction allows entry of communication content delivery location identifier (87). Another feature of the communication content delivery location profile field (84) can be a communication content category selector (88) which by user interaction allows selection of one or more communication content categories (89) of publications (81) receivable at the communication content delivery location (73), such as: newsletters, notices, coupons, restaurant specials, concerts, and movie information, or the like. Another feature of the communication content delivery location profile field (84) can be an active-inactive status selector (90) which by user interaction allow the recipient (79) to select whether the communication content delivery location (73) is actively receiving publications (81) or is inactive and not receiving publications (81). The active-inactive status selector (90) can further include an active status date range selector (91) which by user interaction allows selection of a date range in which the communication content delivery location (73) will actively receive publications (81). Another feature of the communication content delivery location profile field (84) can be an e-mail account identification field (92) which by user interaction an e-mail account or e-mail address (93) can be entered and associated with the communication content delivery location (73).

Associating an existing email account or e-mail address (93) to the communication content delivery location (73) directs publications (81) to the e-mail inbox (94) associated with the e-mail account (93) entered into the e-mail account identification field (92). The definition or selection of the communication content delivery location (73) bounded by the defined or selected geographic boundary (68) provides one interface that aggregates all publications (81) generated by a plurality of publishers (80) within a geographic target area (66) and by operation of the communication content delivery location profile (77) parametrically delimits the number publications (81) based on selected communication content categories (89).

### Recipient's Graphical User Interface.

Now referring primarily to FIG. 4, which provides an illustrative embodiment of a graphical user interface (17) with which the recipient (79) interacts to have publications (81) delivered to a one more communication content delivery locations (73) from one or more publishers (80). The recipient (79) can interact with a create icon (95), an update icon (96) and a delete icon (97) to correspondingly create a communication content delivery location (73), as above described, or update the communication content delivery location profile (77), as above described, or delete and uncouple the communication content delivery location (73) from the content delivery location profile (77) and user account information (78) by execution of a communication content delivery location deletion module (98). The graphical user interface (17) can include a display of the geographic map space (56) along with a navigation controller (58) and a pointer (48) or other viewable tool to point-click or otherwise identify a location in the geographic map space (56) as a communication content delivery location (73) and delimit a geographic target area (66), as above described.

As shown in FIG. 4, as to particular embodiments, the geographic map space generator (55) can be further executed to implement hover-over interaction between a pointer (48) or other tool and the geographic map space (56). As one example, hover-over interaction with a communication content delivery location (73) can cause generation of a popup display (99) including communication content deliver location data (100) describing the communication content delivery location (73) including, as examples: communication content delivery location identifier (87), active-inactive status, expiration date, or the like.

As shown in FIG. 4, as to particular embodiments, the definition or selection of a communication content delivery location (73) by point-click or hover-over can activate a communication content delivery location list generation module (101) which functions to display a communication content delivery location list (102) describing the communication content delivery location (73). As to particular embodiments, the communication content delivery location list (102) can list all the of the communication content delivery location identifiers (87) within a geographic target area (66) or those communication content delivery locations (73) owned in common by a recipient (79). Point-click or hover-over a communication content delivery location (73) can further cause the communication content delivery location list generation module (101) to highlight or otherwise visually identify the communication content delivery location (73) in the geographic map space (56) and in the a communication content delivery location list (102).

Now referring primarily to FIG. 4, the publications (81) delivered to a communication content delivery location (73), optionally from within a geographic target area (66) defined by a geographic boundary (68), can be retrievably-stored in a second server computer (103). Point-click or hover-over a communication content delivery location (73) can further cause a publication configuration selection module (104) to display a publication configuration selector (105) in the graphical user interface (17).

By user interaction with the communication configuration selector (105), the publications (81) delivered to a communication content delivery location (73) can be displayed in a selected one publication configuration (106), such as: a plurality of still images, a serial order time bound presentation (also referred to as “slide-show presentation”) (107), as shown in the example of FIGS. 4; as a tabular publications list (108), as shown in the example of FIG. 4, a virtual tour, or otherwise. The recipient (79) can concurrently view or toggle between different publication configurations (106). Upon selection of a publication configuration (106), a publication retrieval module (109) causes retrieval of the plurality of publications (81) associated with the selected communication content delivery location (73) stored in the second server computer (103) and causes display of the corresponding publication images (82) in the selected publication configuration (106) in the graphical user interface (17).

As to particular embodiments, the publication images (82) can be presented in the graphical user interface for viewing as a plurality still images. The plurality of still images (82A) can be presented in reduced size and selected by point-click to enlarge.

Particular embodiments provide time bound presentation of each publication image (82) in serial order (each publication image displayed in serial order for a period of time), as shown in the examples of FIG. 4. The computer code (16) can further include a publication image presentation control module (110) which allows the recipient (79) to control serial time bound presentation of the plurality of publication images (82) in the graphical user interface (17). As shown in the example of FIG. 4, a start control (111) by user interaction commences serial time bound presentation of publication images (82). A pause control (112) by user interaction pauses presentation of publication images (82), a rewind control (113) by user interaction represents publication images (82) in reverse serial time bound order, a fast forward control (114) by user interaction increases the rate at which publication images (82) are serially presented in graphical user interface (17). A delete control (115) by user interaction during the period of presentation deletes the corresponding publication (82). As to certain embodiments, the publication image presentation controller (110) further functions to allow adjustment of the time period of publication image (82) presentation in the graphical user interface (17).

As to particular embodiments, the publication configuration selection module (104) by user interaction can function to display the plurality of publications (82) associated with a communication content delivery location (73) as a tabular publications list (108), as shown in the example of FIG. 4. The publication configuration selection module (104) can further function to sort the publications (81) based on metadata to identify one or more of the communication content delivery location, publisher, publication date, publication category, publication rank, and may further allow by user interaction to flag, prioritize, or rank publications.

### Publisher's Graphical User Interface.

Now referring primarily to FIG. 5, which provides an illustrative embodiment of a graphical user interface (17) with which the user (20) as a publisher (80) interacts to deliver publications (81) to one more communication content delivery locations (73) of a corresponding plurality of recipients (79)(collectively referred to as “a campaign”).

### The Campaign Profile.

The graphical user interface (17) can include a display of the geographic map space (56) along with a navigation controller (58), as above described, allowing a publisher (80) to select a viewable portion of the geographic map space (56) which may include a plurality of communication content delivery locations (73)(represented in FIG. 5 as “*”). By use of a pointer (48) or other viewable indicia, the publisher (80) can establish a geographic boundary (68) defining a geographic target area (66), as above described, including a plurality of communication content delivery locations (73). By point-click or hover-over or other user interaction on one or more communication delivery locations (73) or submission of the defined or selected geographic target area (66), a communication content delivery module (116) can function to associate the publisher (80) and publications (81) with the defined or selected communication content delivery locations (73) or all of the plurality of communication content delivery locations (73) within the selected geographic target (66).

The communication content delivery module (116) can further present in the graphical user interface (17) a campaign profile field (117)(as shown in the example of FIG. 5) which allows the publisher (80) to create a campaign profile (118) associated the plurality of communication content delivery locations (73) and one or more publications (81). A feature of the campaign profile field (117) can be a campaign identifier field (119) which by publisher (80) interaction allows entry of campaign identifier (120). Another feature of the campaign profile field (117) can be a communication content category selector (121) which by publisher (80) interaction allows selection of one or more communication content categories (122) of publications (81) deliverable to the plurality of communication content delivery locations (73), such as: newsletters, notices, coupons, restaurant specials, concerts, and movie information, or the like. Another feature of the campaign profile field (117) can be a communication content field (123) and associated communication content browser (124) which functions by publisher (80) interaction to select one or more publications (81) to be associated with the campaign identifier (120) deliverable to communication content delivery locations (73). Another feature of the campaign profile field (117) can be a promotion code field (125) fillable with a promotion code (126) by the publisher (80) to associate publications (81) with the promotion code (126).

Another feature of the campaign profile field (117) can be an campaign active-inactive status selector (127) which by publisher (80) interaction allows selection of a campaign active status (128) in which publications (81) are being delivered to communication content delivery locations (73) or a campaign inactive status (129) and not delivering publications (82) to communication content delivery locations (73). The campaign active-inactive status selector (127) can further include a campaign active status date range selector (130) which by publisher (80) interaction allows selection of a date range in which the campaign will actively deliver publications (81) to recipients (79).

The communication content delivery module (116) can further function to display of campaign performance metrics (135) such as number of publications sent, received, acted-upon, cost and the like associated with a particular campaign identifier (120) to provide a measure of the return on investment for each campaign. In a particular embodiment recipients (79) are highlighted in the geographic map space (56) to allow a publisher (80) to “see” the effect of the campaign within geographic sub-regions of the the geographic map space (56) or geographic target area (66). Working with the campaign profile (118) and campaign performance metrics (135), a publisher user can manipulate subsequent distributions to achieve favorable cost-benefit ratios.

### Revenue Model

The computer-implemented geography-based intercommunication content delivery system (1) can further provide a direct mail that charges publishers (80) for access to communication content delivery locations (73) of recipients (79). As a publisher (80) uses the campaign profile field (117) to develop the campaign profile (118) of a campaign, the campaign content delivery module (116) associates communication content delivery locations (73) within the geographic target area (66) bounded by the selected geographic boundary (68) to the campaign profile (118). Publishers (82) may apply filters included in the campaign profile field (117) including but not limited to, category, date and demographic and life-style data, to further refine the pool of communication content delivery locations (73) encompassed by the campaign profile (118).

Particular embodiments of the computer code (16) further include a campaign cost calculator module (131) which further presents in the graphical user interface (17) a publisher check out icon (133) which by publisher (80) interaction causes the campaign cost calculator module (131) to calculate a campaign cost (132) based on the campaign profile (118) and a unit cost for each communication content delivery location (73), but may be expanded to include a sliding scale of costs based on one or more the characteristics of the communication content delivery location profile (85) of a communication content delivery location (73). The campaign cost calculator module (131) can further function to present the campaign cost (132) in a campaign cost field (134) in the graphical user interface (17) allowing publishers (80) to build campaigns based on budget parameters.

The computer code (16) can further include a campaign billing module (133) which debits publishers (80) based on calculated campaign costs (132) and credits publishers for payments made against calculated campaign costs (132).

As can be easily understood from the foregoing, the basic concepts of the present invention may be embodied in a variety of ways. The invention involves numerous and varied embodiments of a geography-based intercommunication content delivery system (1) and methods for making and using such a geography-based intercommunication content delivery system (1) including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “profile” should be understood to encompass disclosure of the act of “profiling”—whether explicitly discussed or not—and, conversely, were there effectively disclosure of the act of “profiling”, such a disclosure should be understood to encompass disclosure of a “profile” and even a “means for profiling.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the a geography-based intercommunication content delivery systems herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

We claim:

1. A computer-implemented geography-based intercommunication system, comprising:
a memory element;
a server processor in communication with said memory element;
a computer readable program code contained in said memory element executable to:
implement a graphical user interface on a display surface of a plurality of client devices;
display a geographic map space navigable by user interaction with navigation controls to select a viewable portion of said geographic map space in said graphical user interface;
select by user interaction with said graphical user interface at least one communication content delivery location within said geographic map space, said communication content delivery location associated with geographic location coordinates;
associate an electronic address with said communication content delivery location; and
receive a publication directed to said content delivery location at said geographic location coordinates at said electronic address.

2. The computer-implemented geography-based intercommunication system of claim 1, wherein said computer readable program code contained in said memory element is further executable to establish by user interaction in said geographic map space a geographic boundary which delimits a geographic target area surrounding said at least one communication content delivery location.

3. The computer-implemented geography-based intercommunication system of claim 2, wherein said computer readable program code contained in said memory element is further executable to limit publications to those originating within said geographic target area defined by said geographic boundary.

4. The computer-implemented geography-based intercommunication system of claim 2, wherein said computer readable program code contained in said memory element is further executable to limit delivery of publications to said communication content delivery location having a location within said geographic target area defined by said geographic boundary.
